(19) United States
(12) Patent Application Publication
(10) Pub. No.: US 2010/0004022 A1
(43) Pub. Date: Jan. 7, 2010

(54) Method Relating To Radio Communication

(75) Inventor: Staffan Lorentzon, Stockholm (SE)

Correspondence Address: ERICSSON INC., 6300 LEGACY DRIVE, M/S EVR 1-C-11, PLANO, TX, 75024, US

(73) Assignee: TELEFONAKTIEBOLAGET LM ERICSSON (PUBL), Stockholm (SE)

(21) Appl. No.: 11/722,277

(22) PCT Filed: Dec. 21, 2004
(86) PCT No.: PCT/IB04/52878

§ 371 Date: Jun. 20, 2007

(51) Int. Cl. H04W 74/02

(52) U.S. Cl. 455/553.1

(57) ABSTRACT

A method for expansion of communication capacity in a radio communication system (1) including a multi-beam antenna system (3) is described. The antenna beams (5) are divided into groups, where the geographical coverage of each group defines a respective sub-sector (7.1,7.2). The sub-sectors in conjunction provide coverage in a radio sector serviced by the communications system (1). A number of carriers are connected to the multi-beam antenna system (3) via a switch (11) and a combiner network (9). The switch (11) allows each carrier to be selectively switched to the sub-sectors via the combiner network (9). In order to expand communication capacity, at least one new carrier is provided. The antenna beam groups and the respective sub-sectors are re-defined such that the number of sub-sectors 15 (8.1-8.4) is increased. In response to the re-definition of the antenna beam groups and sub-sectors (8.1-8.4), carrier to beam connections are re-configured.

### TECHNICAL FIELD

The present invention pertains to the field of radio communication; and more particularly to the part of this field which is concerned with variation of communication capacity in radio communication systems which employ a multi-beam antenna system.

### BACKGROUND AND RELATED ART

A modern BTS (Base Transceiver Station) often includes a multi-beam antenna system capable of producing an plurality of antenna beams. The BTS is adapted to cover one or more radio sectors. The radio sector may in turn be divided into sub-sectors, where each sub-sector consists of a coverage area defined by one or more of the antenna beams produced by the multi-beam antenna system.

A hybrid-sector structure is a sector area that is covered by one carrier containing, for example, the BCCH (BroadCast Control Channel) and two or more sub-sectors, each capable of containing one or more traffic channel carriers. In the hybrid-sector structure, the possible range for coverage can differ substantially between the BCCH carrier and the traffic channel carriers. In order to align coverage to a common cell boarder, the output power of one or more of the carriers have to be reduced, leading to a potential waste of radio resources.

Consequently, today's multi-beam antenna systems are built to fit the current sector structure. The structure includes one carrier supporting e.g. the BCCH and basically defining the coverage area of the sector. A horizontal beam angle of the BCCH carrier is the same as usual, mostly 120 degrees, in order to fit a cell pattern of the radio network of which the BTS is a part. The BCCH carrier coverage can be achieved using a conventional sector antenna. A number of additional carriers, supporting traffic channels, are used to cover the same area as the BCCH carrier. In the hybrid-sector structure, a traffic channel carrier can preferably be switched on a timeslot basis between the various sub-sectors in order to follow a location of a mobile station to which the traffic channel has been allocated.

In order to expand traffic capacity in a radio sector, more carriers usually have to be combined to the existing antennas. In high capacity systems, where hybrid combiners are normally used, additional combiner levels have to be added stepwise when capacity is expanded. However, each new combiner level will reduce the output power per carrier at an antenna outlet by approximately one half. This will impact the cell planning as outdoor and/or indoor coverage is reduced. An alternative is to add one or more antennas, but this is usually not a realistic option. The reduced output power will influence single-beam systems and multi-beam systems differently. In the single-beam case, the output power decreases on all carriers, and a cell radius will thus shrink. In the multi-beam case, the output power will decrease only on the traffic carriers that are linked to the antenna beams but not on when the whole radio sector is served independently, e.g. with a BCCH operating through a sector antenna. The result is an imbalance in coverage between the antenna beams and the radio sector that must be compensated for by lowering the output power broadcasted in the whole radio sector.

### SUMMARY OF THE INVENTION

A main problem addressed by the invention is how to increase communication capacity in a communication system having a multi-beam antenna system providing a plurality of antenna beams.

The above-indicated problem is solved, in short, according to the following. The antenna beams are divided into groups, where the geographical coverage of each group defines a respective sub-sector. The sub-sectors in conjunction provide coverage in a radio sector serviced by the communications system. A number of carriers are connected to the multi-beam antenna system via a switch and a combiner network. The switch allows each carrier to be selectively switched to the sub-sectors via the combiner network. In order to expand communication capacity, at least one new carrier is provided. The antenna beam groups and the respective sub-sectors are re-defined such that the number of sub-sectors is increased. In response to the re-definition of the antenna beam groups and sub-sectors, carrier to beam connections are re-configured.

An advantage of the above-described method is that no modification of the combiner network is necessary for expansion of communication capacity. Carrier power loss in the sub-sectors is essentially the same before and after expansion of the communication capacity. The method is consequently advantageous for expansion of communication capacity in hybrid-sector structures, since the above-indicated imbalance can be avoided.

The skilled person will appreciate that further objects and advantages are associated with particular embodiments of the invention, as will become clear form the detailed description.

### BRIEF DESCRIPTION OF THE DRAWINGS

FIG. 1 is a block diagram of radio communication system prior to expansion of communication capacity according to the invention.

FIG. 2 is a block diagram of the radio communication system after expansion of communication capacity according to the invention.

FIG. 3 is a flow chart of a method for expansion of communication capacity in a radio communication system according to the invention.

### PREFERRED EMBODIMENTS

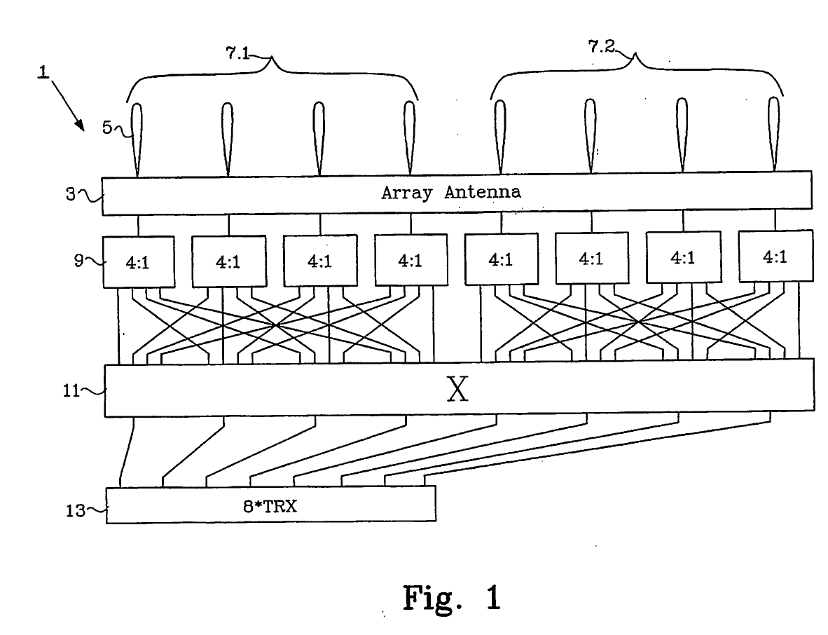

FIG. 1 shows a block diagram of a radio communication system for 1 a BTS. The radio communication system 1 includes a multi-beam antenna system 3, here embodied as an array antenna. The multi-beam antenna system 3 is arranged for providing a number of antenna beams 5 which are divided into antenna beam groups, where each antenna beam group includes at least one of the antenna beams 5. Each group of antenna beams provides coverage in a respective sub-sector of a radio sector served by the radio communication system 1. In the example of FIG. 1, there are eight antenna beams, which are divided into two antenna beam groups, with four antenna beams in each group. Consequently, in the example of FIG. 1, the radio sector includes two sub-sectors 7.1 and 7.2, which are illustrated schematically by brackets in FIG. 1. The radio communication system 1 of FIG. 1 further includes a transceiver bank 13, here including eight transceivers providing carriers, e.g. for traffic channels. Each carrier is connected to a switch 11, which in turn is connected to the multi-beam antenna system 3 via a combiner network including a number of combiners 9. In the example of FIG. 1, there are eight combiners 9. Each combiner 9 is here, by way of example, capable of combining four signals. An output of each combiner 9 is coupled to a respective one of the antenna beams 5. Output ports of the switch 11 are connected to the combiners 9 such that four carries can be used simultaneously in each sub-sector 7.1 or 7.2. The switch 11 makes it possible for each carrier to be selectively switched between the sub-sectors 7.1 and 7.2, e.g. in order to track the motion of a mobile station (not shown) which has been allocated the carrier for radio communications. The switch 11 is preferably operated on a timeslot basis, allowing a different sub-sector selection for each time slot and each carrier.

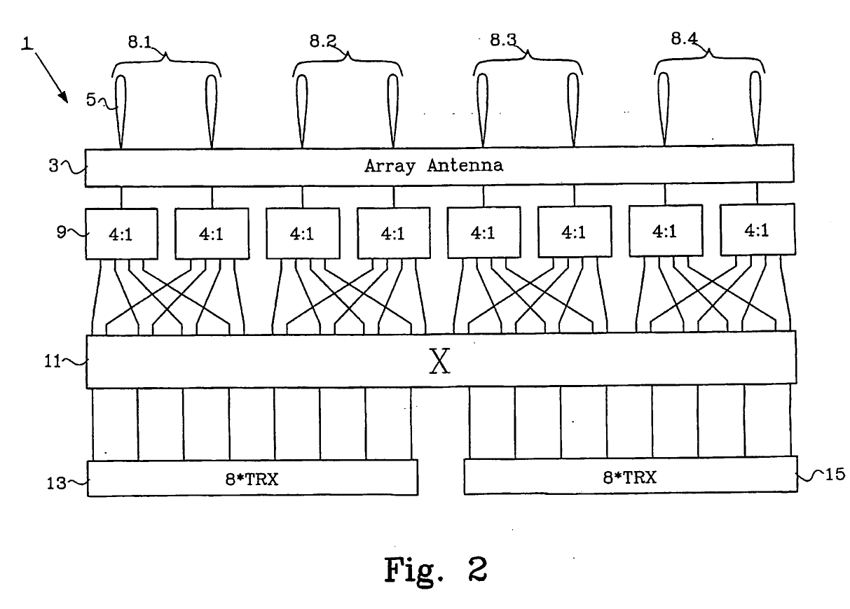

In FIG. 1, the radio communication system 1 is shown before communication capacity has been expanded. In FIG. 2, however, a block diagram of the radio communication system 1 is shown after capacity expansion. A further transceiver block 15 has been added, here including eight new transceivers providing new carriers to the BTS in order to expand its communication capacity. The new carriers may for example support traffic channels. In FIG. 2, the antenna beam groups and the respective sub-sectors have been re-defined. In FIG. 2, there are now four antenna beam groups, and each antenna beam group includes two antenna beams. Consequently, in FIG. 2, there is an increased number (four) of sub-sectors 8.1-8.4. The transceiver bank 15 is also connected to the switch 11. Due to the re-definition of the antenna beam groups and the sub-sectors 8.1-8.4, the connections between the carriers and the antenna beams have been re-configured. In particular, the connections between the switch 11 and the combiners 9 have been re-configured such that each of the four now re-defined sub-sectors 8.1-8.4 can simultaneously receive four carriers. The connections between the combiners 9 and the antenna beams 5, however, remain the same.

The radio communication system 1 in FIGS. 1 and 2 can be part of a hybrid-sector structure, which provides a broadcast carrier in addition to the carriers mentioned above. The broadcast carrier is transmitted in a whole radio sector, and not just in sub-sectors, e.g. by means of an additional sector antenna (not shown). The broadcast carrier may for example support a control channel, e.g. a BCCH.

The same combiner limit, in this example four, applies to the radio communication system 1 before as well as after the expansion of capacity in FIGS. 1 and 2. Capacity has thus been expanded without the need to add further hardware, such as further combiner levels. Carrier power loss is, therefore, essentially the same in FIG. 1 and FIG. 2, which makes this manner of expanding communication capacity particularly suitable for hybrid-sector structures.

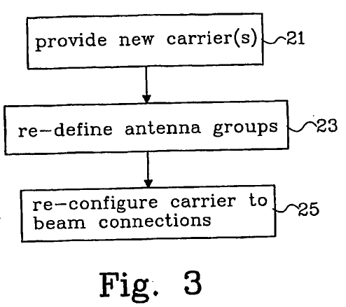

FIG. 3 is a flowchart describing a method for expanding communication capacity of a BTS radio communication system of the type shown in FIG. 1, or similar types of radio communication systems. At a block 21, one or more new carriers, e.g. carriers supporting traffic channels, are provided, e.g. by providing one or more new transceivers. At a block 23, the antenna beam groups are re-defined such that a larger number of antenna beam groups is obtained. The number of respective sub-sectors is consequently also increased. This increase of antenna beam groups and sub-sectors can of course be achieved in various ways. For example, one or more (or all) antenna beam groups may be split into several new (re-defined) antenna beam groups. In the example of FIGS. 1 and 2, each antenna beam group is split into two new antenna beam groups, leading to a doubling of antenna beam groups and sub-sectors. At a block 25, carrier to beam connections are re-configured in response to the re-definition of antenna beam groups and respective sub-sectors. Consequently, each carrier (old and new) is provided with a suitable input connection to the switch, and the connections between the switch and the combiners are re-configured such that each carrier can be selectively switched to any one to the sub-sectors also after the re-definition of the antenna beam groups.

If the number of carriers per sub-sector is below the combiner limit, the method of FIG. 3 needs not to be used, and capacity can in principle be expanded instead by adding new carriers until the combiner limit for each sub-sector has been reached. For example, if the radio communication system 1 of FIG. 1 included less than eight carriers, capacity could be expanded, without re-defining the antenna beam groups, as long as the total number of carries does not exceed eight. If more than eight carriers are to be used, the method in FIG. 3 should be applied.

Consequently, in an alternative to the method in FIG. 3, it is first established whether the number of carriers can be increased without exceeding the current combiner limit of each sub-sector. If so, capacity can be expanded merely by providing the new carriers; no re-definition of antenna beam groups and sub-sectors is necessary. If not so, capacity is expanded by performing the steps in FIG. 3.

1. A method for expanding communication capacity in radio communication system having a multi-beam antenna system providing a plurality of antenna beams which are divided into antenna beam groups where each antenna beam group covers a respective sub-sector of a radio sector serviced by radio communication system, a combiner network connected to the multi-beam antenna system, and a switch connected to the combiner network and capable of selectively switching carriers to the sub-sectors via the combiner network and the multi-beam antenna system, the method characterised by comprising:
providing at least one new carrier;
re-defining the antenna beam groups and the respective sub-sectors such that the number of sub-sectors is increased; and
re-configuring carrier to beam connections in response to the providing of the at least one new carrier and the re-defining of the antenna groups and the respective sub-sectors.

2. The method according to claim 1, wherein the switch is capable of switching the carriers between the sub-sectors on a timeslot basis.

3. The method according to claim 1, wherein a combiner limit per sub-sector is unchanged.

4. The method according to claim 1, wherein the step of re-defining the antenna beam groups comprises splitting at least one of the antenna beam groups into several new antenna beam groups.

5. The method according to claim 1, wherein the step of providing at least one new carrier comprises providing at least one carrier that supports a traffic channel.

6. The method according to claim 1, wherein the method further comprises operating a broadcast carrier in the radio sector.

7. The method according to claim 6, wherein the broadcast carrier supports a control channel.

8. The method according to claim 6, wherein the broadcast carrier is operated through a sector antenna providing an antenna beam covering the radio sector.

9. The method according to claim 1, wherein the method is performed in a base transceiver station.
